(19) United States
(12) Patent Application Publication
(10) Pub. No.: US 2026/0038979 A1
(43) Pub. Date: Feb. 5, 2026

(54) SECONDARY BATTERY

(71) Applicant: SAMSUNG SDI CO., LTD., Yongin-si (KR)

(72) Inventor: Taewoong JANG, Yongin-si (KR)

(21) Appl. No.: 19/003,092

(22) Filed: Dec. 27, 2024

(30) Foreign Application Priority Data
Aug. 5, 2024 (KR) 10-2024-0103810

(51) Int. Cl. H01M 50/533; H01M 50/109; H01M 50/153; H01M 50/474; H01M 50/486; H01M 50/586; H01M 50/595

(52) U.S. Cl. CPC H01M 50/533; H01M 50/109; H01M 50/153; H01M 50/474; H01M 50/486; H01M 50/586; H01M 50/595

(57) ABSTRACT

A secondary battery includes an electrode assembly including a first electrode, a separator, and a second electrode, a case accommodating the electrode assembly, the case being electrically connected to the second electrode, a cap assembly sealing an opening of the case, the cap assembly being electrically connected to a first electrode tab of the first electrode, and an insulating sheet disposed between the cap assembly and the electrode assembly, wherein the first electrode tab is bent two or more times, the first electrode tab being coupled to the cap assembly.

### CROSS-REFERENCE TO RELATED APPLICATION

The present application claims priority to and the benefit of Korean Application No. 10-2024-0103810, filed on Aug. 5, 2024, in the Korean Intellectual Property Office, the entire disclosure of which is incorporated by reference herein.

### BACKGROUND

### 1. Field

The present disclosure relates to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a secondary battery, the secondary battery including an electrode assembly including a first electrode, a separator, and a second electrode, a case accommodating the electrode assembly, the case being electrically connected to the second electrode, a cap assembly sealing an opening of the case, the cap assembly being electrically connected to a first electrode tab of the first electrode, and an insulating sheet disposed between the cap assembly and the electrode assembly, wherein the first electrode tab is bent two or more times, the first electrode tab being coupled to the cap assembly.

The first electrode tab may include a base portion parallel to a winding axis on an outer surface of the electrode assembly, an extension portion bent inwardly in a radial direction from the base portion, the extension portion being on the insulating sheet, a coupling portion bent in an opposite direction to the extension portion, the coupling portion being parallel to the extension portion and coupled to the cap assembly, and a bending portion between the extension portion and the coupling portion.

The coupling portion may be separated from the extension portion by a predetermined interval.

The bending portion may be separated by a predetermined interval in a hollow at a center of the electrode assembly.

The secondary battery may further include an insulating tape attached to at least one surface of the extension portion.

The insulating tape may be attached continuously from the extension portion to one region of the coupling portion.

The bending portion may include notch grooves bent inward on opposite ends thereof.

A width of the bending portion may be 40% to 60% of a width of the coupling portion.

The secondary battery may further include an insulating tape attached continuously from the extension portion to one region of the coupling portion, wherein the insulating tape has a width greater than a width of the extension portion and a width of the coupling portion.

The insulating tape may include insertion grooves having a same shape as the notch grooves.

A width of the extension portion may be smaller than a width of the coupling portion.

The width of the extension portion may be 40% to 60% of the width of the coupling portion.

An inclined surface connected from the bending portion to the coupling portion may be round.

The secondary battery may further include an insulating tape attached continuously from the extension portion to one region of the coupling portion, the insulating tape having a width greater than the width of the coupling portion.

A width of a second region attached to the extension portion may be smaller than a width of a first region attached to the coupling portion.

An inclined surface connected from the second region to the first region may be round.

The insulating sheet may include a base layer including an insulating material, and a layer of polytetrafluoroethylene (PTFE) (e.g., Teflon) on a surface of the base layer facing the first electrode tab.

The first electrode tab may include a base portion in a direction parallel to a winding axis on an inner surface of the electrode assembly, an extension portion bent outwardly in a radial direction from the base portion, the extension portion being on the insulating sheet, a coupling portion bent in an opposite direction to the extension portion, the coupling portion being parallel to the extension portion and coupled to the cap assembly, and a bending portion between the extension portion and the coupling portion.

The coupling portion may be separated from the extension portion by a predetermined interval.

The first electrode tab may include an insulating tape attached to at least one surface of the extension portion.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a sectional view illustrating an example of a secondary battery according to one or more embodiments of the present disclosure.

FIG. 2 is an exploded perspective view illustrating an example of a secondary battery according to one or more embodiments of the present disclosure.

and FIG. 3 is a sectional view illustrating an example in which a secondary battery according to one or more embodiments of the present disclosure is assembled.

FIG. 4 is a diagram illustrating an example of the electrode tab in the secondary battery according to one or more embodiments of the present disclosure.

FIGS. 5 to 8 are diagrams illustrating other examples of the electrode tab in the secondary battery according to one or more embodiments of the present disclosure.

FIG. 9 is a diagram illustrating an example of the insulating sheet in the secondary battery according to one or more embodiments of the present disclosure.

FIG. 10 is a sectional view illustrating an example of a secondary battery according to another embodiment of the present disclosure.

FIG. 11 is an exploded perspective view illustrating an example of the secondary battery according to still another embodiment of the present disclosure.

FIG. 12 is a sectional view illustrating an example in which the secondary battery according to still another embodiment of the present disclosure is assembled.

FIG. 13 is a diagram illustrating an example of the insulating sheet in the secondary battery according to yet another embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or smaller than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

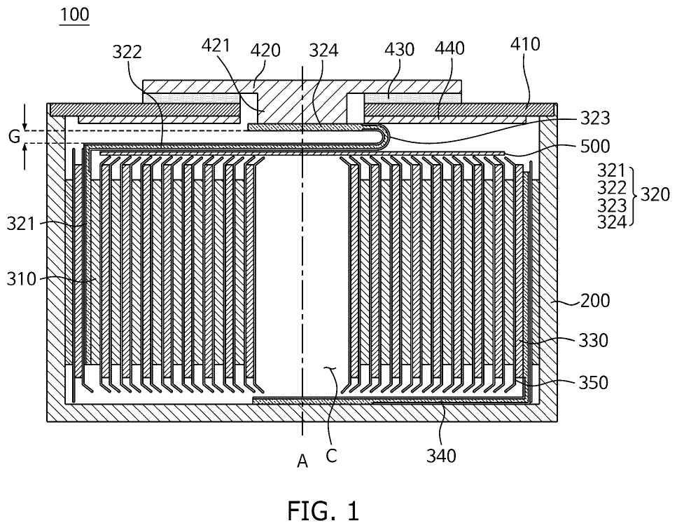

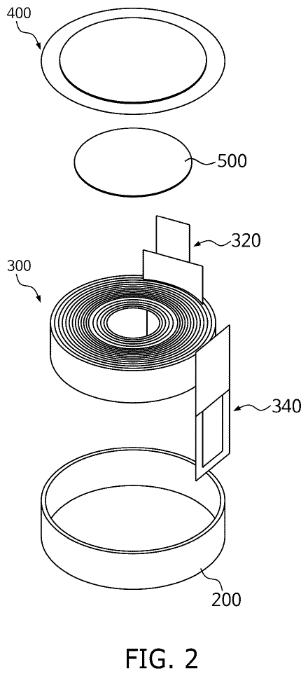

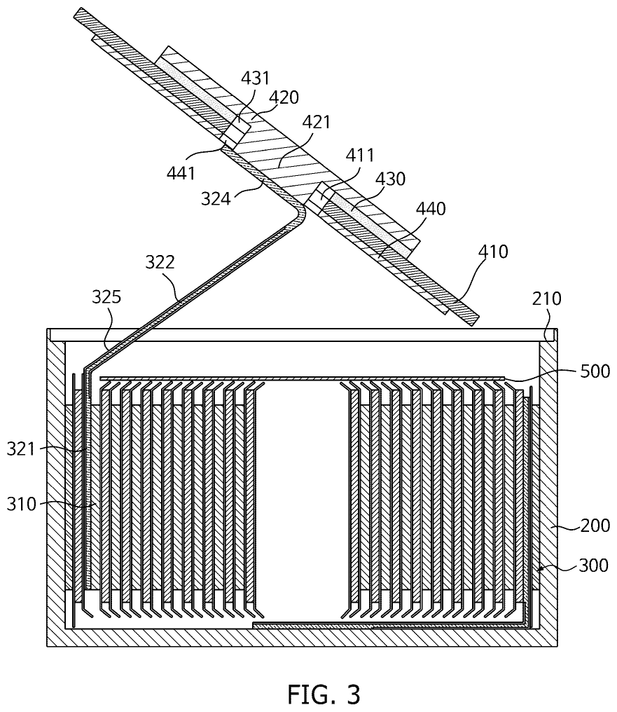

FIG. 1 is a sectional view illustrating an example of a secondary battery according to some embodiments of the present disclosure, FIG. 2 is an exploded perspective view illustrating an example of a secondary battery according to some embodiments of the present disclosure, and FIG. 3 is a sectional view illustrating an example in which a secondary battery according to some embodiments of the present disclosure is assembled.

Referring to FIGS. 1 to 3, a secondary battery 100 according to one or more embodiments of the present disclosure may include an electrode assembly 300 including a first electrode 310, a separator 350, and a second electrode 330, a case 200 in which the electrode assembly 300 is accommodated and which is electrically connected to the second electrode 330, a cap assembly 400 that seals an opening of the case 200 and that is electrically connected to a first electrode tab 320 of the first electrode 310, and an insulating sheet 500 disposed between the cap assembly 400 and the electrode assembly 300.

The electrode assembly 300 may include the separator 350 and the first electrode 310 and the second electrode 330 positioned with the separator 350 interposed therebetween and may be wound in a jelly-roll shape.

The first electrode 310 includes a first substrate and a first active material layer on the first substrate. The first electrode tab 320 may extend outwardly from a first uncoated portion of the first substrate where the first active material layer is not located, and the first electrode tab 320 may be electrically connected to the cap assembly 400.

The second electrode 330 includes a second substrate and a second active material layer on the second substrate. A second electrode tab 340 may extend outwardly from a second uncoated portion of the second substrate where the second active material layer is not located, and the second electrode tab 340 may be electrically connected to the case 200. The first electrode tab 320 and the second electrode tab 340 may extend in opposite directions.

The first electrode 310 may act as a positive electrode. In such an embodiment, the first substrate may be made of, for example, an aluminum foil, and the first active material layer may include, for example, a transition metal oxide. The second electrode 330 may act as a negative electrode. In such an embodiment, the second substrate may be made of, for example, a copper foil or a nickel foil, and the second active material layer may include graphite, for example.

The separator 350 prevents a short circuit between the first electrode 310 and the second electrode 330 while allowing movement of lithium ions therebetween. The separator 350 may be made of, for example, a polyethylene film, a polypropylene film, a polyethylene-polypropylene film, or the like.

The case 200 accommodates the electrode assembly 300 and forms an external appearance of the secondary battery together with the cap assembly 400. The case 200 may have a substantially cylindrical body portion and a bottom portion connected to one side (for example, to one end) of the body portion. The case 200 may be made of a metal, such as aluminum, aluminum alloy, or nickel-plated steel. The second electrode tab 340 may be attached to the bottom portion of the case 200 and may be electrically connected.

The cap assembly 400 may include a cap plate 410 having a through-hole 411 formed therein, a terminal plate 420 disposed on the cap plate 410 and including a projection 421 inserted into the through-hole 411, and an upper insulator 430 disposed between the cap plate 410 and the terminal plate 420.

The cap plate 410 may be formed in a disk shape with the through-hole 411 formed in a center. The cap plate 410 may be formed to have a larger diameter than the terminal plate 420 and the upper insulator 430. The cap plate 410 may be inserted into a fastening groove 210 formed to be dent (e.g., indented, depressed or cut) in an upper end of the case 200 to seal the opening of the case 200. However, in one or more other embodiments, a shape of the cap plate 410 may be formed in various shapes so as to correspond to a shape of the case to which the cap plate 410 is fastened.

The terminal plate 420 may be formed in a circular plate shape with a smaller diameter than the cap plate 410, and the projection 421 may be formed in the center to be inserted into the through-hole 411 of the cap plate 410. The projection 421 may be formed to protrude outwardly from the cap plate 410 while being inserted into the through-hole 411. Such a projection 421 may be configured to be attached to the first electrode tab 320. A shape of the terminal plate 420 is not limited to a circular plate shape, and may be formed in various shapes so as to correspond to the shape of the cap plate 410. In this manner, the first electrode tab 320 may be attached to the projection 421, and the second electrode tab 340 may be attached to the case 200. As a result, the terminal plate 420 may function as a positive electrode and the case 200 may function as a negative electrode.

The upper insulator 430 may be disposed between the cap plate 410 and the terminal plate 420 to electrically insulate the cap plate 410 and the terminal plate 420. Because the cap plate 410 and the terminal plate 420 are made of a conductive metal material and are electrically connected to the cathode which is the second electrode tab 340 and the anode which is the first electrode tab 320, respectively, the upper insulator 430 may insulate the cap plate 410 and the terminal plate 420 to prevent a short circuit from occurring. Such an upper insulator 430 may be made of resin such as polypropylene (PP) or polyethylene (PE).

The upper insulator 430 may be formed in a disk shape with an insertion hole 431 formed in a center, similar to the cap plate 410. With this configuration, the projection 421 of the terminal plate 420 may be disposed to penetrate the insertion hole 431 of the upper insulator 430 and the through-hole 411 of the cap plate 410, and thus, the first electrode tab 320 may be attached to the projection 421. An outer diameter of the upper insulator 430 may be formed to a size equal to or similar to an outer diameter of the terminal plate 420. The cap plate 410 may be formed to have an outer diameter larger than the upper insulator 430 and the terminal plate 420. A diameter of the insertion hole 431 of the upper insulator 430 may be formed to have a size equal to or similar to a diameter of the through-hole 411 of the cap plate 410.

The upper insulator 430 may be attached to the cap plate 410 and the terminal plate 420 by a thermal-fusion method by heating and pressurizing the cap plate 410 and the terminal plate 420 in a state of being disposed between the cap plate 410 and the terminal plate 420.

A lower insulator 440 may be disposed between the cap plate 410 and the first electrode tab 320 to insulate the cap plate 410 and the first electrode tab 320.

In a case where the cap plate 410 is connected to the case 200 and functions as the cathode which is the same electrode as the case 200, because the first electrode tab 320 functions as the anode, the lower insulator 440 may insulate the cap plate 410 and the first electrode tab 320 to prevent a short circuit from occurring. Such a lower insulator 440 may be made of resin such as polypropylene (PP) or polyethylene (PE).

The lower insulator 440 may be formed in a disk shape with an insertion hole 441 formed in a center, similar to the cap plate 410. With this configuration, the projection 421 of the terminal plate 420 may be disposed to penetrate the insertion hole 441 of the lower insulator 440 and the through-hole 411 of the cap plate 410, and thus, the first electrode tab 320 may be attached to the projection 421. An outer diameter of the lower insulator 440 may be formed to a size equal to or similar to an outer diameter of the electrode assembly 300. The lower insulator 440 may be formed to have an outer diameter smaller than the cap plate 410. A diameter of the insertion hole 441 of the lower insulator 440 may be formed to have a size equal to or smaller than a diameter of the through-hole 411 of the cap plate 410 such that the cap plate 410 is not exposed toward the first electrode tab 320.

For example, the lower insulator 440 may be made of an insulating tape and may be attached to a bottom surface of the cap plate 410, or may be made of an insulating sheet and may be attached to the bottom surface of the cap plate 410 by a thermal-fusion method.

The insulating sheet 500 may be disposed on an upper portion of the electrode assembly 300 to insulate the upper portion of the electrode assembly 300 and the first electrode tab 320.

The battery (for example, a secondary battery) described with reference to FIG. 1 may be a coin or button battery. However, the battery may be other types of secondary batteries (for example, cylindrical batteries). In FIG. 1, although it has been illustrated that the first electrode tab protrudes upward to be connected to the cap assembly and the second electrode tab protrudes downward to be connected to the case, both the first electrode tab and the second electrode tab may be configured to protrude upward to be connected to the cap assembly and the case, respectively.

The first electrode tab 320 according to one or more embodiments of the present disclosure may be bent two or more times and may be coupled to the cap assembly 400. For example, as illustrated in FIG. 1, after the first electrode tab 320 extends from the electrode assembly 300, and the first electrode tab may be first bent upward of the electrode assembly 300 and then bent a second time in an opposite direction, an end may be connected to the projection 421 of the terminal plate 420.

In one or more embodiments, the first electrode tab 320 may include a base portion 321 disposed in a direction parallel to a winding axis A on an outer surface of the electrode assembly 300, an extension portion 322 bent inwardly in a radial direction from the base portion 321 and disposed on the insulating sheet 500, a coupling portion 324 bent in an opposite direction to the extension portion 322, disposed parallel to the extension portion 322, and coupled to the cap assembly 400, and a bending portion 323 formed between the extension portion 322 and the coupling portion 324.

With this configuration, referring to FIG. 3, after the coupling portion 324 is connected to the projection 421, the extension portion 322 may be settled on an upper side of the insulating sheet 500, and the extension portion 322 and the coupling portion 324 may be bent in a foldable form. As a result, the cap assembly 400 may be connected to the case 200.

In a state where the cap assembly 400 is coupled to the case 200, the coupling portion 324 may be disposed to face the extension portion 322, and the coupling portion 324 and the extension portion 322 may be disposed to be separated from each other by a predetermined interval G (see FIG. 1). The coupling portion 324 may be disposed parallel to the extension portion 322. With this configuration, the coupling portion 324 and the extension portion 322 may be separated from each other while forming the bending portion 323 to provide an elastic force between the cap assembly 400 and the electrode assembly 300. As a result, the shaking of the electrode assembly 300 within the case 200 can be minimized.

In order for the bending portion 323 to more effectively support the electrode assembly 300, the bending portion 323 may be disposed to be separated from a hollow C (see FIG. 1) formed at a center of the electrode assembly 300 by a predetermined interval. When the bending portion 323 is disposed on an upper side of the hollow C, because a load applied to the bending portion 323 is distributed to the hollow C and may not support the electrode assembly 300, the bending portion 323 may be disposed to avoid the hollow C.

An insulating tape 325 may be attached to the first electrode tab 320 for electrical insulation. The insulating tape 325 may be attached to one surface or both surfaces (e.g., an upper surface and/or lower surface in the orientation of FIG. 1) of the extension portion 322. Because the extension portion 322 is disposed between the electrode assembly 300 and the cap plate 410, the insulating tape 325 may be attached to one surface or both surfaces of the extension portion 322.

The insulating tape 325 may be attached continuously from the extension portion 322 to one region of the coupling portion 324. For example, the insulating tape may be attached to one region of the extension portion 322, the bending portion 323, and the coupling portion 324. Because the coupling portion 324 is connected to the projection 421, the insulating tape 325 may be attached to a region of the coupling portion 324 except for the region connected to the projection 421.

Because the bending portion 323 is configured to provide an elastic force between the cap plate 410 and the electrode assembly 300, the insulating tape 325 may be attached for more stable electrical insulation. As the insulating tape 325 is attached to the bending portion 323, the elasticity of the insulating tape 325 may be added, and thus, a greater elastic force may be provided to the cap plate 410 and the electrode assembly 300.

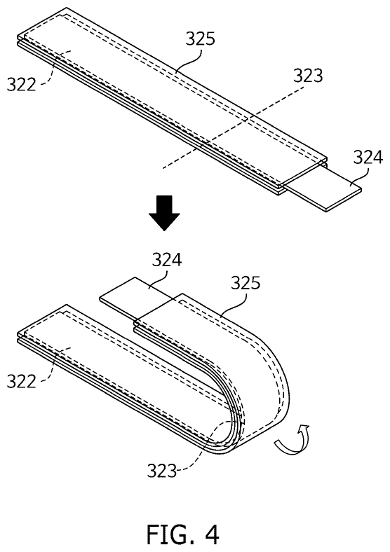

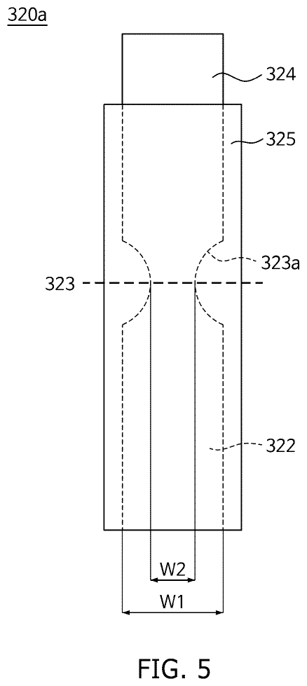

FIG. 4 is a diagram illustrating an example of the electrode tab in the secondary battery according to some embodiments of the present disclosure, and FIGS. 5 to 8 are diagrams illustrating other examples of the electrode tab in the secondary battery according to some embodiments of the present disclosure.

Referring to FIG. 4, the first electrode tab 320 according to some embodiments may be formed in a square (e.g., rectangular) plate shape. The extension portion 322, the bending portion 323, and the coupling portion 324 may be continuously formed, and the first electrode tab 320 may be bent. As a result, the extension portion 322, the bending portion 323, and the coupling portion 324 may be partitioned.

The insulating tape 325 may be attached to the extension portion 322, the bending portion 323, and both surfaces of the coupling portion 324. The insulating tape 325 may be formed to have a width greater than a width of the extension portion 322 and a width of the coupling portion 324. In one example, an end of the coupling portion 324 may be formed such that the insulating tape 325 is not attached to a certain region or more and is exposed to an outside. The region of the coupling portion 324 exposed to the outside may be a region coupled to the projection of the terminal plate.

Referring to FIG. 5, a first electrode tab 320a according to another embodiment may be formed in a square plate shape and may include notch grooves 323a in one region. For example, the extension portion 322, the bending portion 323, and the coupling portion 324 may be continuously formed, and the notch grooves 323a may be formed to be dent inward (e.g., indented, depressed, or cut) at both ends of the bending portion 323. With this configuration, a position of the bending portion 323 may be set.

A width W2 of the bending portion 323 may be formed to a length of 40% to 60% of a width W1 of the coupling portion 324. In some embodiments, the widths W1 of the coupling portion 324 and the extension portion 322 may be the same. For example, when the widths W1 of the coupling portion 324 and the extension portion 322 are 2.5 mm to 3.0 mm, the width W2 of the bending portion 323 may be formed to have a width of 1.0 mm to 1.8 mm.

When the width W2 of the bending portion 323 is formed to a length smaller than 40% of the width W1 of the coupling portion 324, the elastic force applied between the cap plate and the electrode assembly may decrease, and thus, a supporting force of the electrode assembly may decrease. The electrode tab may be more easily broken as the load is repeatedly applied to the bending portion 323. When the width W2 of the bending portion 323 is formed to a length exceeding 60% of the width W1 of the coupling portion 324, a bending effect by the notch groove 323a may be minimal. Accordingly, the width W2 of the bending portion 323 may be formed to a length of 40% to 60% of the width W1 of the coupling portion 324.

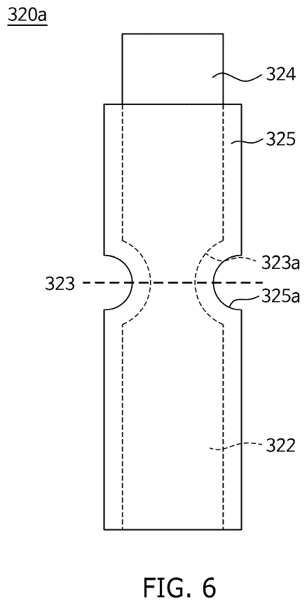

The insulating tape 325 may be formed to have a width greater than the width of the extension portion 322 and the width of the coupling portion 324, and thus, the insulating tape may continuously cover one region of the extension portion 322, the bending portion 323, and the coupling portion 324. In other embodiments, as illustrated in FIG. 6, the insulating tape 325 may include insertion grooves 325a having a shape corresponding to the notch grooves 323a. With this configuration, the position of the bending portion 323 may be set more accurately.

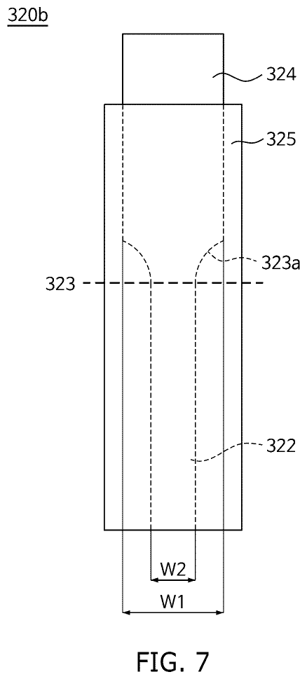

Referring to FIG. 7, a first electrode tab 320b according to another embodiment may be formed in a square (e.g., rectangular) plate shape, and the width W2 of the extension portion 322 may be formed to be smaller than the width W1 of the coupling portion 324. The width W2 of the extension portion may be formed to a length of 40% to 60% of the width W1 of the coupling portion 324.

In one or more embodiments, a boundary region between the extension portion 322 and the coupling portion 324 may correspond to the bending portion 323. Notch grooves 323a connected from the bending portion 323 to the coupling portion 324 may be formed to be rounded (e.g., curved). The notch grooved 323a correspond to the bending portion 323, and when an angular shape is formed in the bent region, a fatigue failure may easily occur due to stress concentration. Accordingly, the notch grooves 323a may be formed to be rounded such that stress is not concentrated on the bending portion 323.

The insulating tape 325 may be formed to have a width greater than the width of the extension portion 322 and the width of the coupling portion 324, and thus, the insulating tape may continuously cover one region of the extension portion 322, the bending portion 323, and the coupling portion 324. As illustrated in FIG. 7, the insulating tape 325 may be formed to have the same width from the extension portion 322 to the coupling portion 324.

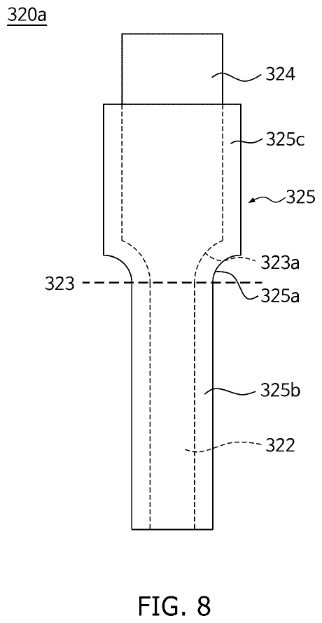

In one or more other embodiments, referring to FIG. 8, the insulating tape 325 may be formed such that a width of a second region 325b attached to the extension portion 322 is smaller than a width of a first region 325c attached to the coupling portion 324. For example, the insulating tape may be formed in a shape corresponding to the shapes of the extension portion 322 and the coupling portion 324. The insulating tape 325 may be formed such that insertion grooves 325a connected from the second region 325b to the first region 325a is rounded. For example, because the notch grooves 323a connected from the bending portion 323 to the coupling portion 324 is formed to be rounded (e.g., curved), the insertion grooves 325a may be formed to be rounded corresponding to the notch grooves 323a.

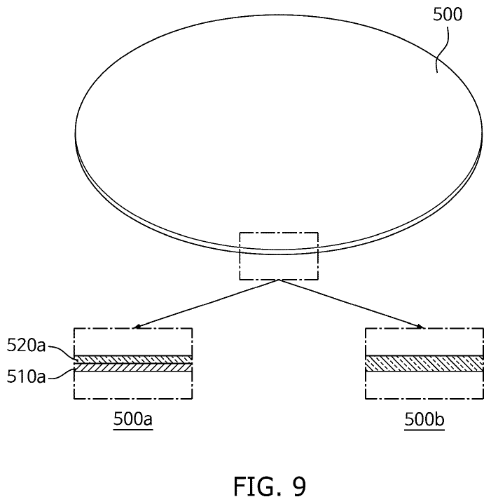

FIG. 9 is a diagram illustrating an example of the insulating sheet in the secondary battery according to some embodiments of the present disclosure.

Referring to FIG. 9, the insulating sheet 500 may be disposed between the cap assembly and the electrode assembly to electrically insulate the cap assembly and the electrode assembly, and may be made of a resin such as polypropylene (PP) or polyethylene (PE).

An upper surface of the insulating sheet 500 (in the orientation shown) may be a region where the first electrode tab comes into contact, and continuous friction may occur with the first electrode tab. Accordingly, an insulating sheet 500a may include a base layer 510a made of an insulating material such as polypropylene (PP) or polyethylene (PE), and a polytetrafluoroethylene (PTFE) layer 520a disposed on a surface of the base layer 510a facing the first electrode tab. The PTFE may be a material with excellent properties resistant to friction, and the PTFE can reduce friction with the first electrode tab and can prevent the insulating sheet from being damaged.

In other embodiments, an insulating sheet 500b may be made of PTFE (e.g., only PTFE). Because the PTFE also has excellent electrical insulation properties, the insulating sheet 500b may be manufactured using the PTFE material without a separate base layer.

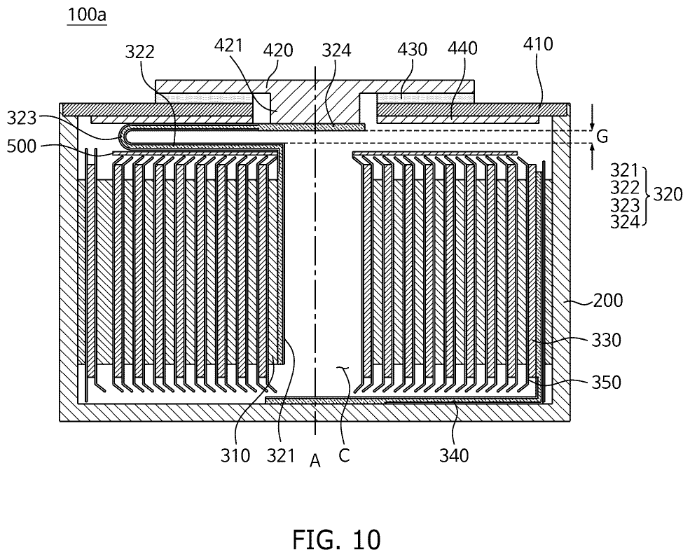

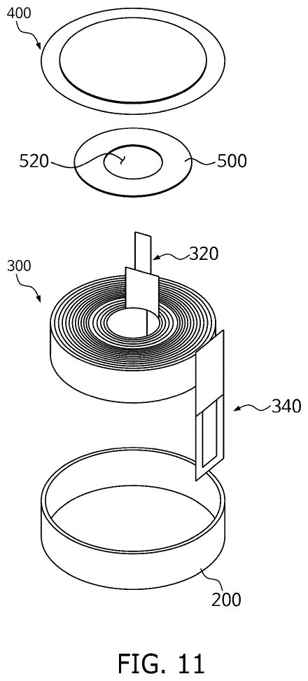

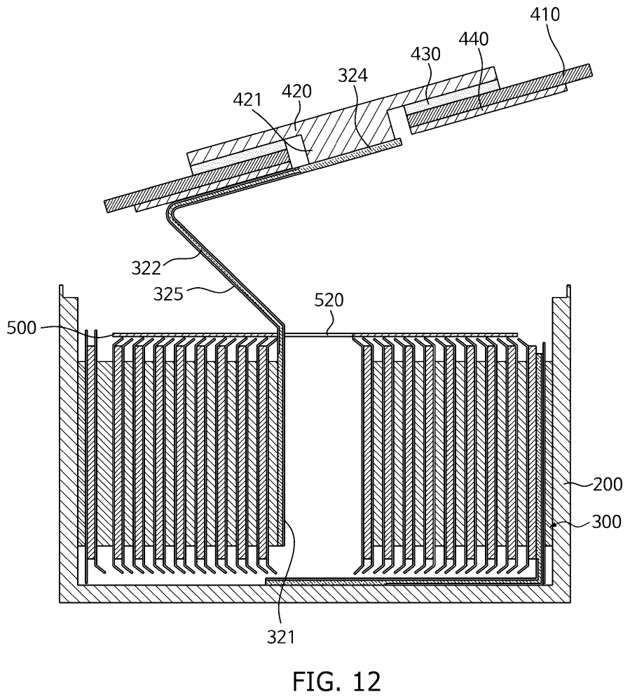

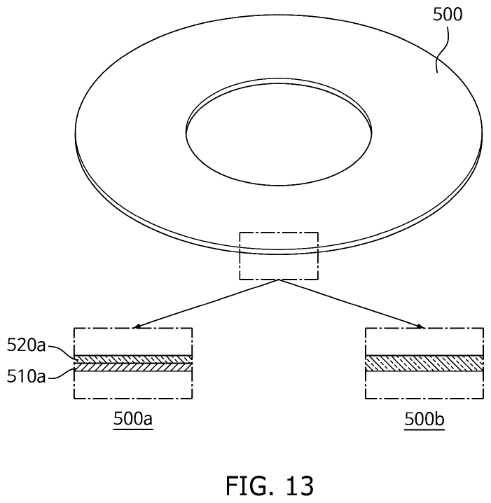

FIG. 10 is a sectional view illustrating an example of a secondary battery according to another embodiment of the present disclosure, FIG. 11 is an exploded perspective view illustrating an example of the secondary battery according to another embodiment of the present disclosure, and FIG. 12 is a sectional view illustrating an example in which the secondary battery according to another embodiment of the present disclosure is assembled. FIG. 13 is a diagram illustrating an example of the insulating sheet in the secondary battery according to another embodiment of the present disclosure.

Referring to FIGS. 10 to 13, a secondary battery 100a according to another embodiment of the present disclosure may include an electrode assembly 300 including a first electrode 310, a separator 350, and a second electrode 330, a case 200 in which the electrode assembly 300 is accommodated and which is electrically connected to the second electrode 330, a cap assembly 400 that seals an opening of the case 200 and is electrically connected to a first electrode tab 320 of the first electrode 310, and an insulating sheet 500 disposed between the cap assembly 400 and the electrode assembly 300.

In some embodiments, the case 200 and the cap assembly 400 have substantially the same configuration as the case 200 and the cap assembly 400 described with reference to FIG. 1, and thus, the detailed description will be omitted. In the secondary battery 100a according to another embodiment of the present disclosure, a position of the electrode assembly 300 where the first electrode tab 320 is formed may be formed to be different from the secondary battery 100 described with reference to FIG. 1.

The first electrode tab 320 according to another embodiment of the present disclosure may also be bent two or more times and may be coupled to the cap assembly 400. For example, as illustrated in FIG. 10, after the first electrode tab 320 extends from a center of the electrode assembly 300, and the first electrode tab may be first bent upward of the electrode assembly 300 and then bent a second time in an opposite direction, an end may be connected to a projection 421 of a terminal plate 420.

In some embodiments, the first electrode tab 320 may include a base portion 321 disposed in a direction parallel to a winding axis A on an inner surface of the electrode assembly 300, an extension portion 322 bent outwardly in a radial direction from the base portion 321 and disposed on the insulating sheet 500, a coupling portion 324 bent in an opposite direction to the extension portion 322, disposed parallel to the extension portion 322, and coupled to the terminal plate 420, and a bending portion 323 formed between the extension portion 322 and the coupling portion 324.

With this configuration, referring to FIG. 12, after the coupling portion 324 is coupled to the projection 421, the extension portion 322 may be settled on an upper side of the insulating sheet 500, and the extension portion 322 and the coupling portion 324 may be bent in a foldable form. As a result, the cap assembly 400 may be assembled to the case 200.

In a state where the cap assembly 400 is coupled to the case 200, the coupling portion 324 and the extension portion 322 may be disposed parallel to each other so as to face each other, and the coupling portion 324 and the extension portion 322 may be disposed to be separated from each other by a predetermined interval G (see FIG. 10). With this configuration, the coupling portion 324 and the extension portion 322 may be separated from each other while forming the bending portion 323 to provide an elastic force between the cap assembly 400 and the electrode assembly 300. As a result, shaking of the electrode assembly 300 within the case 200 can be minimized. The first electrode tab 320 may be in the form described above with reference to FIGS. 5 to 8.

An insulating tape 325 may be attached to the first electrode tab 320 for electrical insulation. The insulating tape 325 may be attached to one surface or both surfaces (e.g., top and bottom surfaces in the orientation shown in FIG. 10) of the extension portion 322. With the extension portion 322 being disposed between the electrode assembly 300 and the cap plate 410, the insulating tape 325 may be attached to one surface or both surfaces of the extension portion 322.

The insulating tape 325 may be attached continuously from the extension portion 322 to one region of the coupling portion 324. For example, the insulating tape may be attached to one region of the extension portion 322, the bending portion 323, and the coupling portion 324. With the coupling portion 324 being connected to the projection 421, the insulating tape 325 may be attached to a region of the coupling portion 324 except for the region connected to the projection 421.

The insulating sheet 500 may be disposed between the cap assembly and the electrode assembly to electrically insulate the cap assembly and the electrode assembly, and may be made of a resin such as polypropylene (PP) or polyethylene (PE). The insulating sheet 500 may include a through-hole 520 formed in a center with a size corresponding to a hollow C of the electrode assembly 300. The first electrode tab 320 may extend from a center of the electrode assembly 300 and may be inserted into the through-hole 520 of the insulating sheet 500 and then disposed on an upper surface of the insulating sheet 500.

Referring to FIG. 13, the upper surface of the insulating sheet 500 may be a region where the first electrode tab comes into contact, and continuous friction may occur with the first electrode tab. Accordingly, an insulating sheet 500a may include a base layer 510a made of an insulating material such as polypropylene (PP) or polyethylene (PE), and a polytetrafluoroethylene (PTFE) layer 520a disposed on a surface of the base layer 510a facing the first electrode tab. The PTFE may be a material with excellent properties resistant to friction, and the PTFE can reduce friction with the first electrode tab and can prevent the insulating sheet from being damaged.

In other embodiments, an insulating sheet 500b may be made of PTFE. Because the PTFE also has excellent electrical insulation properties, the insulating sheet 500b may be manufactured by using the PTFE material without a separate base layer.

Electrode tabs of the electrode assembly accommodated in a case may be fastened by welding to the case or to a cap assembly that seals the case. However, when the case vibrates or is dropped, the electrode assembly may shake inside the case, and thus, continuous damage may be caused in the electrode tabs. As a result, the electrode tabs may be broken.

According to some embodiments of the present disclosure, a gap between the electrode assembly and the cap assembly accommodated in the case can be minimized.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of ordinary skill in the art that various changes in form and details may be made without departing from the spirit and scope of the present invention as set forth in the following claims.

[DESCRIPTION OF SOME REFERENCE SYMBOLS]

| | |
|---|---|
| 100: secondary battery | 200: case |
| 300: electrode assembly | 310: first electrode |
| 320: first electrode tab | 321: base portion |
| 322: extension portion | 323: bending portion |
| 324: coupling portion | 325: insulating tape |
| 330: second electrode | 350: separator |
| 400: cap assembly | 410: cap plate |
| 420: terminal plate | 430: upper insulator |
| 440: lower insulator | 500: insulating sheet |
| 520: through-hole | |

What is claimed is:

1. A secondary battery, comprising:
an electrode assembly comprising a first electrode, a separator, and a second electrode;
a case accommodating the electrode assembly, the case being electrically connected to the second electrode;
a cap assembly sealing an opening of the case, the cap assembly being electrically connected to a first electrode tab of the first electrode; and
an insulating sheet disposed between the cap assembly and the electrode assembly,
wherein the first electrode tab is bent two or more times, the first electrode tab being coupled to the cap assembly.

2. The secondary battery as claimed in claim 1, wherein the first electrode tab comprises:
a base portion parallel to a winding axis on an outer surface of the electrode assembly;
an extension portion bent inwardly in a radial direction from the base portion, the extension portion being on the insulating sheet;
a coupling portion bent in an opposite direction to the extension portion, the coupling portion being parallel to the extension portion and coupled to the cap assembly; and
a bending portion between the extension portion and the coupling portion.

3. The secondary battery as claimed in claim 2, wherein the coupling portion is separated from the extension portion by a predetermined interval.

4. The secondary battery as claimed in claim 2, wherein the bending portion is separated by a predetermined interval in a hollow at a center of the electrode assembly.

5. The secondary battery as claimed in claim 2, further comprising an insulating tape attached to one surface or both surfaces of the extension portion.

6. The secondary battery as claimed in claim 5, wherein the insulating tape is attached continuously from the extension portion to one region of the coupling portion.

7. The secondary battery as claimed in claim 2, wherein the bending portion comprises notch grooves bent inward on opposite ends thereof.

8. The secondary battery as claimed in claim 2, wherein a width of the bending portion is 40% to 60% of a width of the coupling portion.

9. The secondary battery as claimed in claim 7, further comprising:
an insulating tape attached continuously from the extension portion to one region of the coupling portion,
wherein the insulating tape has a width greater than a width of the extension portion and a width of the coupling portion.

10. The secondary battery as claimed in claim 9, wherein the insulating tape comprises insertion grooves having a same shape as the notch grooves.

11. The secondary battery as claimed in claim 2, wherein a width of the extension portion is smaller than a width of the coupling portion.

12. The secondary battery as claimed in claim 11, wherein the width of the extension portion is 40% to 60% of the width of the coupling portion.

13. The secondary battery as claimed in claim 11, wherein an inclined surface connected from the bending portion to the coupling portion is round.

14. The secondary battery as claimed in claim 11, further comprising an insulating tape attached continuously from the extension portion to one region of the coupling portion, the insulating tape having a width greater than the width of the coupling portion.

15. The secondary battery as claimed in claim 14, wherein a width of a second region attached to the extension portion is smaller than a width of a first region attached to the coupling portion.

16. The secondary battery as claimed in claim 15, wherein an inclined surface connected from the second region to the first region is round.

17. The secondary battery as claimed in claim 1, wherein the insulating sheet comprises:
a base layer including an insulating material; and
a layer of polytetrafluoroethylene (PTFE) on a surface of the base layer facing the first electrode tab.

18. The secondary battery as claimed in claim 1, wherein the first electrode tab comprises:
a base portion in a direction parallel to a winding axis on an inner surface of the electrode assembly;
an extension portion bent outwardly in a radial direction from the base portion, the extension portion being on the insulating sheet;
a coupling portion bent in an opposite direction to the extension portion, the coupling portion being parallel to the extension portion and coupled to the cap assembly; and
a bending portion between the extension portion and the coupling portion.

19. The secondary battery as claimed in claim 18, wherein the coupling portion is separated from the extension portion by a predetermined interval.

20. The secondary battery as claimed in claim 18, wherein the first electrode tab comprises an insulating tape attached to one surface or both surfaces of the extension portion.
